(19) United States
(12) Patent Application Publication
(10) Pub. No.: US 2016/0126582 A1
(43) Pub. Date: May 5, 2016

(54) PREFORMATION OF STABLE SOLID ELECTROLYTE INTERFACE FILMS ON GRAPHITE-MATERIAL ELECTRODES

(71) Applicant: Battelle Memorial Institute, Richland, WA (US)

(72) Inventors: Jie Xiao, Richland, WA (US); Yuyan Shao, Richland, WA (US); Dongping Lu, Richland, WA (US); Wendy D. Bennett, Kennewick, WA (US); Jun Liu, Richland, WA (US); Ji-Guang Zhang, Richland, WA (US); Gordon L. Graff, West Richland, WA (US)

(73) Assignee: Battelle Memorial Institute

(21) Appl. No.: 14/529,840

(22) Filed: Oct. 31, 2014

(51) Int. Cl. H01M 10/02; H01M 10/04; H01M 10/058; H01M 10/0525; H01M 10/0569

(52) U.S. Cl. CPC H01M 10/02; H01M 10/0525; H01M 10/0569; H01M 10/058; H01M 10/04; H01M 2300/0028

(57) ABSTRACT

Disclosed are preformed solid electrolyte interface (SEI) film graphite electrodes in lithium-sulfur based chemistry energy storage systems and methods of making the preformed SEI films on graphite electrodes to expand the use of graphite-based electrodes in previously non-graphite anode energy systems, such as lithium-sulfur battery systems. Also disclosed are lithium-ion sulfur battery systems comprising electrolytes that do not include an alkyl carbonate, such as those that do not include EC, and graphite anodes having preformed alkyl carbonate, such as EC-based SEI films.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

The present disclosure relates to use of graphite-material electrodes in energy systems such as lithium-sulfur type battery systems, and more particularly to the preformation of ethylene carbonate solid electrolyte interface films on graphite-material electrodes for use in such systems.

### BACKGROUND

With growing public concern about environmental and energy issues, considerable effort has been devoted to further development of electrochemical energy-storage technologies. Anode materials for such battery systems is one key area of interest. While graphite has been commonly used as anode material for certain state-of-the-art lithium-ion batteries, it has not been used in lithium-sulfur type energy storage systems such as battery systems due to the need to use ethylene carbonate electrolytes with graphite-material anodes. Carbonated-based electrolytes, such as those including an ethylene carbonate (EC) solvent, cannot be used in lithium-sulfur battery systems or other lithium-sulfur energy storage systems where alkyl carbonate electrolytes cannot be used due to the interactions of alkyl carbonates and the dissolved polysulfide species in these lithium-sulfur type energy storage systems.

### SUMMARY

Disclosed are lithium-ion sulfur energy storage systems with preformed solid electrolyte interface (SEI) film graphite electrodes, e.g., anodes, and methods of making the preformed SEI films on graphite electrodes. The disclosed energy storage systems with preformed SEI graphite film electrodes expand the use of graphite-based electrodes in lithium-sulfur chemistry energy storage systems which are known to be non-graphite anode chemistries, particularly for lithium sulfur batteries, because traditional EC-containing electrolytes cannot be used in such systems. Specifically, disclosed are lithium-ion sulfur type energy storage systems comprising graphite-material electrodes, such as lithium-ion sulfur battery systems using electrolytes that do not contain alkyl carbonates. Further disclosed are sulfur chemistry based energy storage systems comprising non-alkyl carbonate, such as non-EC, containing electrolytes and graphite anodes having preformed EC-based SEI films. Also disclosed are lithium-ion sulfur battery systems comprising graphite-material anodes having preformed EC SEIs for use in systems having electrolytes that do not comprise or include alky carbonates, such as EC-based electrolytes but instead use for example, ether-based electrolytes.

Further disclosed are embodiments of convenient methods to make lithium-ion sulfur energy storage systems, particularly lithium-ion sulfur battery systems, comprising preformed SEI films on graphite anodes, which preformed SEI films allow the utilization of graphite anodes in a variety of non-EC or other non-alkyl carbonate containing electrolytes, particularly, for example, ether-based electrolytes. The preformed SEI film on the graphite electrodes, as used herein, functions as a protection layer (passivation layer) in other types of electrolytes, such as ether-based electrolytes, allowing the transport of Li ions within and throughout the graphite electrode without the co-intercalation of solvents in the electrolyte. The SEI film exhibits lithium-ion conductivity but does not exhibit electron conductivity. The SEI film also acts to inhibit graphite exfoliation.

Further disclosed are particular embodiments of a device comprising a lithium-ion sulfur battery system comprising a graphite anode having a preformed alkyl carbonate based SEI film and an electrolyte not including an alkyl carbonate. In some embodiments the preformed alkyl carbonate SEI film comprises preformed SEI films from EC pretreatment solutions. In some embodiments the preformed alkyl carbonate SEI film comprises SEI films preformed in dimethyl carbonate (DMC) pretreatment solutions. In some embodiments the SEI film is preformed in pretreatment solutions comprising EC and/or DMC and further comprising SO₂, Li₂CO₃, K₂CO₃, lithium bis (oxalato) borate (LiBOB), ethylene sulfite (ES), propylene sulfite (PS), vinyl ethylene sulfite (VES), prop-1-ene-1,3-sultone (PES), vinylene trithiocarbonate (VTC), fluoroethylene carbonate (FEC), vinylene carbonate (VC), vinylethylene carbonate (VEC), or mixtures thereof. In some embodiments the electrolyte comprises an ether-based electrolyte. In yet other embodiments the electrolyte comprises lithium bis-trifluoromethanesulfonamide (LiTFSI), lithium bis(fluorosulfonyl)amide (LiFSI), lithium trifluoromethanesulfonate (Li triflate) and/or, (lithium 4,5-dicyano-2-(trifluoromethyl) imidazole (LiTDI) and a solvent comprising dimethyl ether, 1,2-dimethoxyethane (DME), 1,3-dioxolane (DOL), dimethyl sulfoxide (DMSO), diethylene glycol dimethyl ether (diglyme), triethylene glycol dimethyl ether (triglyme), tetra ethylene glycol dimethylether (tetraglyme), sulfone and their binary or ternary mixtures, and mixtures thereof. In some embodiments the graphite anode is a substantially pure graphite anode.

Further disclosed are particular embodiments of a device comprising a lithium-ion sulfur battery system further comprising a graphite anode having a preformed SEI film and a non-alkyl carbonate containing electrolyte useful for charging and discharging the lithium-ion sulfur battery system without significant decline in specific capacity in over 10 cycles of charging and discharging. In some embodiments the preformed SEI film comprises a film formed in a pretreatment solution comprising EC. In some embodiments the SEI film is preformed in a pretreatment solution consisting essentially of EC.

Also disclosed are certain embodiments of a method comprising making a graphite electrode capable of use in a lithium-ion sulfur battery system by providing an untreated graphite electrode, the graphite electrode having a surface, providing an alkyl carbonate containing solution, prior to placing the graphite electrode in the lithium-ion sulfur battery system, immersing the untreated graphite anode in the alkyl carbonate containing pretreatment solution thereby preforming a SEI film on the surface of the graphite electrode, removing the graphite anode having the preformed SEI film thereon, and placing the graphite electrode having the preformed SEI film thereon in an electrolyte, wherein the electrolyte does not comprise an alkyl carbonate. In some embodiments the method further comprises charging and discharging the lithium-ion sulfur battery system. In some embodiments the method further comprises placing the graphite electrode having the preformed SEI film thereon into a lithium-sulfur supercapacitor and operating the supercapacitor in an electrolyte that does not contain an alkyl carbonate. In some embodiments the method includes providing an SEI film preformed in a pretreatment solution comprising EC, DMC, ethyl methyl carbonate (EMC), diethyl carbonate (DEC), EC/DMC, EC/EMC, EC/DEC, EC/PC (propylene carbonate), or mixtures thereof. In certain embodiments the method further comprises providing a pretreatment solution comprising EC, EC and a co-solvent, EC and EMC, EC and PC, EC and DEC, or EC and DMC. In certain embodiments the method further comprises providing the EC pretreatment solution at a temperature such that the EC is a liquid in the absence of a co-solvent.

Further disclosed are methods comprising making a preformed SEI film graphite electrode by providing an untreated graphite electrode, providing an alkyl carbonate pretreatment containing solution, precycling the untreated graphite electrode in the alkyl carbonate pretreatment containing solution thereby preforming an SEI film on the surface of the graphite electrode, and cycling the graphite electrode having the preformed SEI film thereon in a lithium-sulfur battery system in an electrolyte, wherein the electrolyte does not comprise an alkyl carbonate. In certain embodiments the methods further comprise providing an SEI film preformed in an EC containing pretreatment solution. In certain embodiments the methods further comprise providing an electrolyte comprising an ether-based composition. In certain embodiments the methods further comprise providing an electrolyte comprising lithium bis-trifluoromethanesulfonamide (LiTFSI), lithium bis(fluorosulfonyl)amide (LiFSI), lithium 4,5-dicyano-2-(trifluoromethyl) imidazole (LiTDI) and/or Li triflate and a solvent comprising dimethyl ether, 1,2-dimethoxyethane (DME), 1,3-dioxolane (DOL), dimethyl sulfoxide (DMSO), diethylene glycol dimethyl ether (diglyme), triethylene glycol dimethyl ether (triglyme), tetra ethylene glycol dimethyl ether (tetraglyme), sulfone and their binary or ternary mixtures, and mixtures thereof.

The foregoing and other objects, features, and advantages of the invention will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a graph of charge and discharge curves and cycling stability of an untreated graphite anode in a lithium-ion sulfur battery system, cycling the untreated graphite anode in LiTFSI (DOL/DME (1:1)) electrolyte (E121).

FIG. 2 is a digital photograph of the untreated graphite anode at the discharged (lithiated) state after 10 cycles; the black color of the graphite electrode at the lithiated state indicates the graphite loses activity for lithium ion storage.

FIG. 3 is a graph of charge and discharge curves and cycling stability of an embodiment of the preformed SEI film graphite electrode disclosed herein, the graphite electrode SEI film comprising an organic/inorganic film preformed from a LiPF₆ in EC/DMC (1:2) (E102) pretreatment solution and then cycled in LiTFSI (DOL/DME (1:1)) electrolyte (E121) with cycling conditions of 0.01-1.5V, 0.1 C charge/discharge.

FIG. 4 is a digital photograph of the preformed SEI film graphite electrode of FIG. 3 at the discharged state (lithiated) after 10 cycles with the cycling conditions of 0.01-1.5V, 0.1 C charge/discharge. The golden color of the graphite electrode at the lithiated state indicates high activity of graphite for lithium ion storage.

FIG. 5 is a graph of the results of the extended cycling data of a preformed SEI film graphite anode formed from a pretreatment solution comprising LiPF₆ in EC/DMC (1:2) (E102) and then cycled in LiTFSI (DOL/DME) electrolyte.

FIG. 6 is a graph of the cycling data obtained when cycling a preformed SEI film graphite anode in LiPF₆ in EC/DMC (1:1) (E102) pretreatment solution to preform the SEI film thereon and then cycling the preformed SEI film graphite anode in LiTFSI (DOL/DME) (E121) electrolyte.

FIG. 7 is a graph of comparison data of the cycling stability of the graphite electrode with and without preformed SEI film in different electrolytes, i.e., E102, E121, and preformed by dipping in an E102 pretreatment solution and then cycled in E121.

FIG. 8 is a graph of charge/discharge curves of an embodiment of the disclosed lithium-ion sulfur cell with a sulfur cathode and preformed SEI film graphite anode preformed in a pretreatment solution comprising an EC/DMC solution.

### DETAILED DESCRIPTION

The following explanations of terms and abbreviations are provided to better describe the present disclosure and to guide those of ordinary skill in the art in the practice of the present disclosure. As used herein, “comprising” means “including” and the singular forms “a” or an or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought as known by those persons of ordinary skill in the art or limits of detection under standard test conditions/methods, as known to those persons of ordinary skill in the art. When directly and explicitly distinguishing embodiments from discussed prior art, the embodiment numbers are not approximates unless the word “about” is recited.

To facilitate review of the various embodiments of the disclosure, the following explanations of specific terms are provided:

Alkyl refers to a hydrocarbon group having a saturated carbon chain. The chain may be cyclic, linear or branched. The term lower alkyl means the chain includes 1-10 carbon atoms.

Anode: An electrode through which electric charge flows into a polarized electrical device. From an electrochemical point of view, negatively-charged anions move toward the anode and/or positively-charged cations move away from it to balance the electrons arriving from external circuitry. In a discharging battery, such as the disclosed lithium/ion batteries or a galvanic cell, the anode is the negative terminal where electrons flow out. If the anode is composed of a metal, electrons that it gives up to the external circuit are accompanied by metal cations moving away from the electrode and into the electrolyte.

Anode active material: A material that is included in an anode and produces the electrons that flow out of the anode in a discharging battery.

Cell: As used herein, a cell refers to an electrochemical device used for generating a voltage or current from a chemical reaction, or the reverse in which a chemical reaction is induced by a current. Examples include voltaic cells, electrolytic cells, redox flow cells, and fuel cells, among others. A battery includes one or more cells. The terms “cell” and “battery” are used interchangeably only when referring to a battery containing a single cell.

Coin cell: A small, typically circular-shaped battery. Coin cells are characterized by their diameter and thickness. For example, a type 2325 coin cell has a diameter of 23 mm and a height of 2.5 mm.

EC-based SEI film or layer: as used herein is a preformed SEI film formed on a graphite electrode in an EC containing pretreatment solution.

An electrolyte: is a substance containing free ions that behaves as an electrically conductive medium. Electrolytes generally comprise ions in a solution, but molten electrolytes and solid electrolytes also are known.

Ether-based electrolyte: is a solution in which one or more Li ion containing salts are dissolved in a single or multiple solvents, which include at least one ether compound. A typical concentration of the salt in the solvent may be from 0.1-10 mol/L of salt in the solvent or may be from 1-5 mol/L.

Li ion containing Salt: is a compound comprising, consisting of or consisting essentially of one or more of lithium bis-trifluoromethanesulfonamide (LiTFSI), lithium bis(fluorosulfonyl)amide (LiFSI), lithium 4,5-dicyano-2-(trifluoromethyl) imidazole (LiTDI) and/or lithium triflate.

Ether based solvent: is a solvent comprising, consisting essentially of or consisting of one or more of dimethyl ether, 1,2-dimethoxyethane (DME), 1,3-dioxolane (DOL), dimethyl sulfoxide (DMSO), diethylene glycol dimethyl ether (diglyme), triethylene glycol dimethyl ether (triglyme), tetra ethylene glycol dimethyl ether (tetraglyme), sulfone and their binary or ternary mixtures, and mixtures thereof.

Half-cell: As used herein, a half-cell is an electrochemical cell including a lithium metal negative electrode, another working electrode as the positive electrode, a separator, and an electrolyte.

Intercalation: A term referring to the insertion of a material (e.g., an ion, molecule, or group) between the atoms, molecules, or groups of another material. For example, lithium ions can insert, or intercalate, into graphite (C) to form lithiated graphite (LiC₆).

Preformed SEI: As used herein, preformed means an SEI film formed on the electrode in a pretreatment solution before the electrode is (1) placed in the battery system for cycling (meaning charging and discharging) of the energy storage system, such as a battery, that uses an electrolyte that does not include an alkyl carbonate, other carbonates or does not include ethylene carbonate specifically or (2) before the electrode is placed in or cycled in the electrolyte that does not include an alkyl carbonate, other carbonates or does not include ethylene carbonate specifically that is ultimately used to operate the energy storage or battery system, so as to act as an energy storage device.

Specific capacity: A term that refers to capacity per unit of mass. Specific capacity may be expressed in units of mAh/g, and often is expressed as mAh/g carbon when referring to a carbon-based electrode.

Lithium batteries, such as lithium-ion batteries, typically comprise two components that participate in electrochemical reactions to produce energy: an anode and a cathode. Lithium-ion batteries produce energy through electrochemical reactions occurring between the anode and cathode. Typically both the anode and cathode are made of materials into which, and from which, lithium ions can intercalate and de-intercalate. During battery discharge, lithium ions de-intercalate from the anode material and migrate to the cathode into which they insert. During a charging cycle, the opposite reaction occurs, i.e., lithium ions are extracted from the cathode material and migrate back to the anode where they reinsert.

In a conventional lithium battery, charging occurs when lithium ions migrate from the cathode to the anode, as shown in the representative forward reactions below:

LiCoO₂ [symbol] Li₁₋ₓCoO₂+xLi⁺+xe⁻ cathode half reaction:

xLi⁺+xe⁻+6C [symbol] LiₓC₆ anode half reaction:

Discharge occurs when the reactions run in reverse.

Lithium or other metal alloy-based anodes for lithium batteries often exhibit poor cycle life and fast capacity fade that results from electrode cracking and pulverization due to the high volume change associated with lithium alloying and de-alloying processes with the anode during the charge and discharge cycles, respectively.

In non-alkyl carbonate (e.g., non-EC) based electrolyte battery systems (particularly ether-based electrolytes) used for cycling lithium-sulfur battery systems, many of the problems stem from use of lithium-metal or lithium-alloy based electrodes. Despite the problems encountered with Li-metal anodes, use of such anodes has persisted in lithium-sulfur battery systems for about the last 40 years. While graphite-material based anodes are commonly used for some types of lithium-ion battery systems, graphite (or graphite material based) anodes cannot be used in lithium-sulfur battery systems (or other sulfur chemistry energy storage systems such as capacitors) because ethylene-carbonates, needed to form an SEI layer on the graphite surfaces cannot be used in these types of lithium-sulfur chemistry systems.

More specifically, due to the problems presented by Li-metal anodes in lithium-sulfur battery systems, the inventors attempted to use graphite anodes in a non-alkyl carbonate (such as a non-EC) containing electrolyte battery systems (particularly lithium-sulfur systems) despite the entrenched belief that graphite anodes could not be used in lithium-sulfur systems. Non-alkyl carbonate electrolytes, such as ether-based electrolytes, are required for use in lithium-sulfur systems because alkyl carbonate electrolytes, such as EC-containing electrolytes, interact with the dissolved polysulfide species in such systems. However, graphite electrodes without a passivation layer, such as an SEI film, are either not active in non-alkyl carbonate electrolyte battery systems or are susceptible to exfoliation based on the electrolytes used. Appropriate compounds such as EC have to be used in the electrolyte in lithium-ion battery systems to form a stable SEI film on the graphite anode surface, which only allows the insertion or deintercalation of Lit Otherwise, the solvents coordinated with Li⁺ will co-intercalate into graphite layers of the anode and “exfoliate” the graphite structure leading to quick degradation and not allowing significant (greater than 50 cycles) battery or capacitor cycling without significant loss in specific capacity such that the device is not useful and/or economically useful as an energy storage device or system.

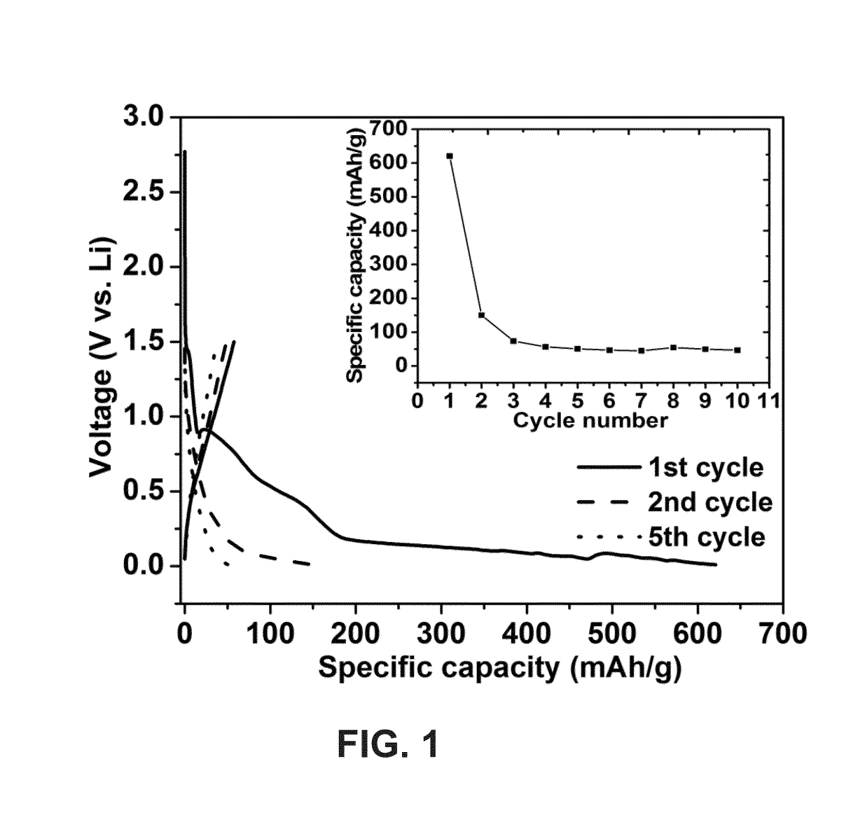

As illustrated by the test results shown in FIG. 1, an untreated graphite anode was tested for use in a lithium-sulfur battery system by cycling the untreated graphite anode in lithium bis(trifluoromethanesulfonyl)imide (LiTFSI) and (1,3 dioxaolane/dimethoxyethane) (DOL/DME) (E121) electrolyte. By untreated graphite anode is meant a graphite anode without an SEI film or layer formed thereon, either prior to cycling of the battery system or following initial cycling of the battery system. As can be seen from the cycling data generated, a graphite anode in a non-alkyl carbonate electrolyte and in the absence of an SEI film (i.e., without an SEI film) formed thereon does not cycle beyond the first discharge. While the first discharge performs at a specific capacity of greater than about 600 mAh/g, following cycles are at, or nearly at, zero. The cycling conditions in this example were: 0.01-1.5V, 0.1 C charge/discharge (1 C=350 mA/g).

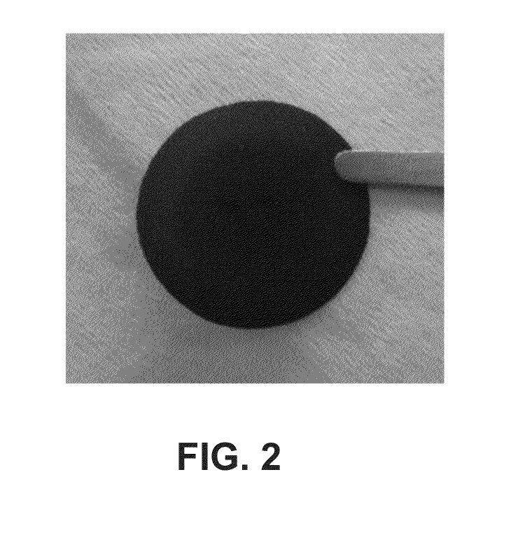

As further evidence of the inoperability of a graphite anode in the absence of an SEI film formed thereon, FIG. 2 is a digital photograph of a graphite anode at the discharged (lithiated) state from the cycling illustrated in FIG. 1. As can be seen, the graphite anode after discharge (cycled 10 times) failed to lithiate. A lithiated graphite anode turns golden in color but here the graphite remained black in color indicating the graphite was not lithiated and thus was not active in the battery system.

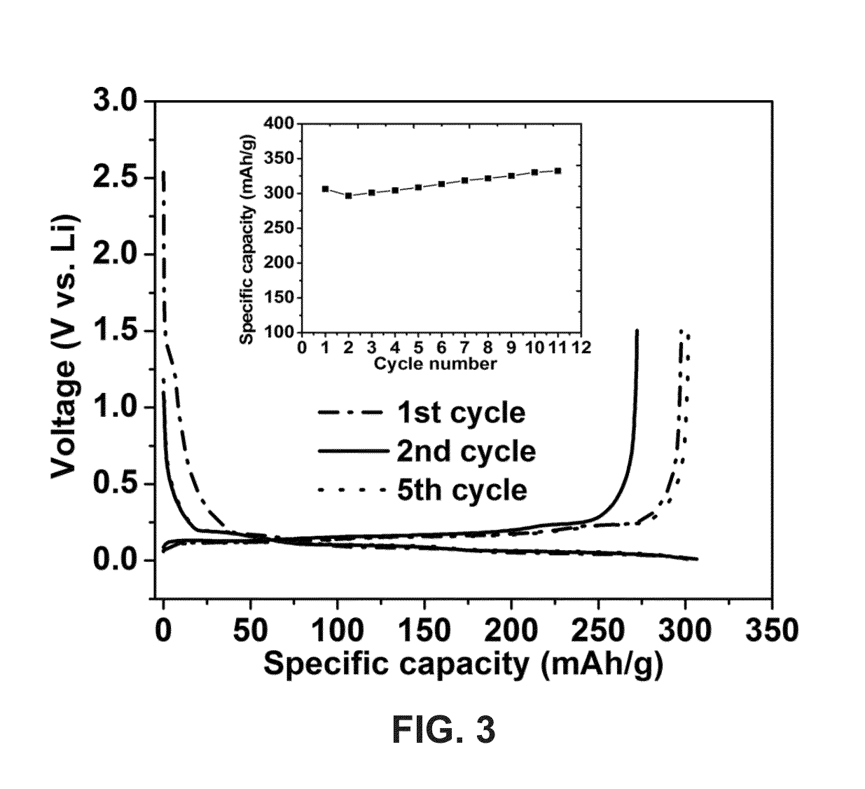

While conventional wisdom argued against using graphite in lithium-sulfur battery systems because alkyl carbonate electrolytes and solvents, such as EC, are not compatible with polysulfide and react with polysulfides to generate inactive byproducts, and non-alkyl carbonate electrolytes cannot form the necessary SEI layer. Thus when the inventors preformed an SEI film on the graphite anode and then used the preformed SEI graphite electrode in a non-alkyl carbonate electrolyte, such as an ether-based electrolytes the inventors were not only surprised it worked but were surprised it actually provided superior results, as described below with reference to FIGS. 3-6.

It was surprisingly found that, when prior to use in a lithium-sulfur system, by first immersing the graphite electrode in an EC-containing solution or electrolyte, the chemically preformed EC-based SEI layer on the graphite electrode effectively protects the graphite when used later in energy systems, such as batteries, redox flow batteries, supercapacitors, and capacitors, which use non-alkyl carbonate (e.g., non-EC) electrolytes, such as ether-based electrolytes and allows the graphite electrode to be active in such systems. SEI layers preformed in EC or EC/DMC pretreatment solutions showed good stability and mechanical strength even when the graphite electrodes having the preformed SEI films were placed in non-alkyl carbonate electrolytes, such as those used in lithium-sulfur battery systems. Stable cycling was demonstrated using a graphite electrode with a preformed EC-based SEI film in ether electrolytes, which otherwise cannot be recharged at all.

Accordingly, disclosed are lithium-ion sulfur battery systems comprising non-alkyl carbonate, such as non-EC, containing electrolytes and graphite electrodes having preformed SEI films, preformed in EC containing pretreatment solutions. As such, after about 40 years of having to use trouble-ridden lithium-metal anodes in such systems, particularly lithium-sulfur battery systems, the preferred graphite anode can be used. Further disclosed are lithium-ion sulfur battery systems having graphite electrodes having preformed EC-based SEI films and further comprising non-alkyl carbonate electrolytes. In certain embodiments, the disclosed lithium-ion sulfur battery systems include the graphite electrode having preformed EC-based SEI films and ether-based electrolytes. In certain embodiments the energy storage systems such as the lithium-ion sulfur battery systems include a sulfur cathode. Also disclosed are methods of making the disclosed lithium-ion sulfur energy storage systems having graphite electrodes with preformed, stable EC-based SEI films for use with electrolytes that do not include an alkyl carbonate such as EC.

Chemical processes in a lithium-ion sulfur battery (sulfur-lithiated graphite battery) as disclosed herein include lithium ion extraction from the anode lithiated graphite (and incorporation into alkali metal polysulfide salts) during discharge, and reverse lithium ion intercalation into the anode while charging. By using preformed SEI-graphite as the anode, Li₂S, and polysulfides Li₂Sₓ (x=1-8) can be used as the cathode directly to form Li₂S-graphite, another type of lithium-ion sulfur battery. Sulfur can host two lithium ions per each sulfur atom, delivering high theoretical gravimetric capacity of 1675 mAh/g. Typically, lithium-ion batteries accommodate only 0.5-0.7 lithium ions per host molecule unit with practical specific capacities of 140-180 mAh/g. Consequently lithium-ion sulfur systems allow for a much higher lithium storage capacity. Polysulfides are reduced on the cathode surface in sequence while the cell is discharging:

S₈→Li₂S₈→Li₂S₆→Li₂S₄→Li₂S₂—Li₂S
Across a porous diffusion separator, sulfur polymers form at the cathode as the cell charges:
Li₂S→Li₂S₂→Li₂S₄→Li₂S₆→Li₂S₈→S₈

In one embodiment a battery system comprises a non-alkyl carbonate electrolyte, such as non-EC electrolyte and a graphite electrode, such as an anode, having a preformed EC-based SEI film. In another embodiment, a lithium-ion sulfur battery system comprises a preformed SEI-layer graphite electrode, a non-alkyl carbonate-based electrolyte such as an ether-based electrolyte, a cathode, such as a sulfur-based cathode like S or polysulfides Li₂Sₓ (x=1-8) and a separator or membrane. The battery system may further include a current collector.

In particular embodiments, the preformed SEI-film graphite electrode comprises, consists essentially of, or consists of, a graphite-material based electrode, such as a pure or substantially pure graphite material electrode or a graphite composite-based electrode, such as a mixture of graphite, carbon conductors such as carbon black, carbon nanotubes, carbon nanofiber, graphene, or reduced graphene oxide and a binder such as polyvinylidene fluoride (PVDF), carboxymethyl cellulose (CMC), styrene-Butadiene Rubber (SBR), polyacrylic acid (PAA), or Li-polyacrylic acid (Li-PAA). The carbon conductor and binder are used to prepare the electrode but do not contribute to the capacity of the graphite electrode and as such may be considered along with other common additives as components described by the language “consisting essentially of.” Other graphite-based electrode composite materials may be used, such as graphite/Li, graphite/SiOₓ, graphite/Si, graphite/Sn, graphite/MOₓ (M: Ti, V, Cr, Fe, Co, Ni, Cu, Zn, Ge, and Sn), which may also be used as anodes for lithium-ion sulfur batteries. For ease of discussion, certain embodiments are disclosed using the language “graphite anode” or “graphite electrode” but should be understood to include the graphite-mixed anode or electrode materials noted above unless the terms “pure graphite” or “substantially pure graphite” are used. A “pure graphite” anode or electrode refers to those made essentially exclusively or exclusively of graphite, to the ability for conventional means to produce the same, but does not include the graphite-mixed anode materials alternatives noted above or other conventional materials added to graphite anodes.

In certain embodiments the preformed SEI film on the graphite anode comprises, consists essentially of, or consists of an SEI film preformed in an alkyl carbonate containing pretreatment solution. In other embodiments the preformed SEI film comprises, consists essentially of, or consists of a SEI film preformed in an EC, DEC (diethyl carbonate), DMC, EMC, EC/DMC, EC/DEC, EC/PC or EC/EMC, containing pretreatment solution.

Other materials or components may be included in the SEI film pretreatment solutions in addition to the above-listed SEI materials, such as SO₂, Li₂CO₃, K₂CO₃, lithium bis (oxalato) borate (Li BOB), ethylene sulfite (ES), propylene sulfite (PS), vinyl ethylene sulfite (VES), prop-1-ene-1,3-sultone (PES), vinylene trithiocarbonate (VTC), fluoroethylene carbonate (FEC), vinylene carbonate (VC), vinylethylene carbonate (VEC) (such SEI film additives and like additives fall within the “consisting essentially of” description). It is worth noting that while SEI films have been under investigation for decades, the exact composition of the films at any particular point in time, exact formation mechanism, and mechanism function are still not fully understood (see, e.g. Nie, M. et al., “Lithium Ion Battery Graphite Solid Electrolyte Interphase Revealed by Microscopy and Spectroscopy,” The Journal of Physical Chemistry, Vol. 117, No. 3, pp. 1257-1267 (January 2013)). As shown in Table 1 below, persons of ordinary skill in the art have made attempts at identifying the exact composition of an SEI film formed in EC electrolytes at various points in time of operation of energy storage devices, yet many cannot agree on the actual compounds present when battery systems with graphite electrodes are operated in systems that operate with EC electrolytes. Verma, P. et al., “A review of the features and analyses of the solid electrolyte interphase in Li-ion batteries,” Electrochimica Acta, Vol. 55, Issue 22, pp. 6332-6341 (September 2010). This is likely because the SEI compositions and films' thicknesses do not stay constant throughout cycling or storage of such energy storage systems.

TABLE 1
Contents of the SEI as reported in the literature

| Component | Present | Not present | Notes |
|---|---|---|---|
| (CH₂OCO₂Li)₂ | Five articles | | Being a two electron reduction product of |
| | | | ethylene carbonate (EC); it is found mostly |
| | | | in the SEI of the EC based electrolytes. |
| ROCO₂Li | Five articles | | They are present in the outer layer of the |
| | | | SEI and are absent near Li. They occur in |
| | | | most propylene carbonate (PC) containing |
| | | | electrolytes, especially when the |
| | | | concentration of PC in the electrolyte is high. |
| Li₂CO₃ | Four articles | Four articles | Not always present. Normally present in the |
| | | | SEI formed in EC or PC based electrolytes. |
| | | | It may also appear as a reaction product of |
| | | | semicarbonates with HF or water or CO₂. |
| ROLi | Seven articles | | Most commonly found in the SEI formed in |
| | | | ether electrolytes like tetrahydrofuran (THF), |
| | | | but may also appear as dimethyl carbonate |
| | | | (DMC) or ethyl methyl carbonate (EMC) |
| | | | reduction product. It is soluble and may |
| | | | thus undergo further reactions. |
| LiF | Three articles | | Mostly found in electrolytes comprising of |
| | | | fluorinated salts like LiAsF₆, LiPF₆, LIBF₄. It |
| | | | is a major salt reduction product. HF |
| | | | contaminant also reacts with semi |
| | | | carbonates to give LiF byproduct. Amount |
| | | | of LiF increases during storage. |
| Li₂O | Three articles | Three articles | It may be a degradation product of Li₂CO₃ |
| Polycarbonates | | | during Ar+ sputtering in the XPS |
| | | | experiment. |
| | Two articles | | Present in the outermost layer of the SEI, |
| | | | close to the electrolyte phase. This part |
| | | | imparts flexibility to the SEI. |
| LiOH | Three articles | Two articles | It is mainly formed due to water |
| | | | contamination. It may also result from |
| | | | reaction of Li2O with water or with ageing. |
| Li₂C2O₄ | Two articles | | It is found to be present in 18650 cells |
| | | | assembled in Argonne National Labs |
| | | | containing 1.2M LiPF₆ in EC:EMC (3:7) |
| | | | electrolyte. Li carboxylate and Li methoxide |
| | | | were also found in their SEI. |
| HCOLi | One articles | | It is present when methyl formate is used as |
| | | | co-solvent or additive. |

In general, the SEI film may be of a thickness of from the 1 nms to 10 microns though it varies during cycling and storage.

The SEI film is preferably formed on the entire or substantially the entire graphite electrode surface. In certain embodiments the SEI film covers at least 50% of the graphite surface, or at least 60%, or at least 70%, or at least 80%, or at least 90% or at least 98% or covers substantially the entire surface, wherein substantially means within the limits of full coverage of such a device surface as would be understood by those of ordinary skill in the art.

Embodiments of the pretreatment solution for forming the SEI film may comprise, consist essentially of or consist of, one or more of the following:
a. An alkyl carbonate;
b. An alkyl carbonate and suitable solvent for the alkyl carbonate if the alkyl carbonate is not sufficiently liquid at room temperature;
c. EC;
d. EC and other co-solvent including, for example, PC, EMC, DMC, DEC, or binary or ternary of the above mixtures, suitable to dissolve EC at room temperature;
e. EC and EMC;
f. EC and DMC;
g. EC and PC;
h. EC and DEC.

Certain of the SEI pretreatment solutions may further comprise additional components or additives (which fall within the “consisting essentially of” description), such as SO₂, Li₂CO₃, K₂CO₃, LiBOB, ethylene sulfite (ES), PS (propylene sulfite), VES (vinyl ethylene sulfite), PES (polyethersulfone), VTC (vinylene trithio carbonate), FEC (fluoroethylene carbonate), VC (vinylene carbonate), and/or VEC (vinyl ethylene carbonate).

The carbonate to solvent ratios in the SEI pretreatment solution are determined to be those that are sufficient to make the alkyl carbonate, such as EC, a liquid at room temperature. In certain embodiments the ratio of the EC to co-solvent ranges from 1:1 to 1:10. In embodiments where the alkyl carbonate is not sufficiently liquid at room temperature, rather than adding a co-solvent to the solution, the alkyl carbonate, such as EC, is warmed to a temperature at which it is sufficiently liquid such that the graphite anode can be immersed into the liquid to preform the SEI film.

In certain embodiments of the disclosed non-alkyl carbonate energy systems, such as lithium-ion sulfur battery systems, capacitors, and redox-flow battery systems, the systems comprise the disclosed preformed SEI film graphite electrodes and further comprise non-alkyl carbonate electrolytes. In other embodiments of the energy systems, such as the lithium-ion sulfur battery systems, the systems comprise the disclosed preformed SEI film graphite electrodes and further comprise ether-based electrolytes. In further embodiments the systems disclosed herein comprise the disclosed preformed SEI film graphite anodes and electrolytes further comprising LiTFSI (lithium bis-trifluoromethane sulfonamide), Li triflate (trifluoromethanesulfonate) or LiFSI (lithium bis(fluorosulfonyl)amide) salts in solvents of DME (1,2-dimethoxyethane), DOL (1,3-dioxolane), DMSO (dimethyl sulfoxide), DEGDME (diethylene glycol dimethyl ether), triglyme, TEGDME (tetra ethylene glycol dimethylether), sulfone and their binary or ternary mixtures, and mixtures thereof. The concentration of the salt in the solvent (not including other solution components) may range from 0.1-10M or 1-5M.

Also disclosed are methods for forming the preformed SEI film on the graphite electrodes for use in energy systems, such as lithium-ion sulfur battery systems. In certain embodiments the graphite electrode is immersed in the SEI pretreatment solution for a relatively short time period, such as for 1 to 2 minutes. In other method embodiments the graphite anodes are soaked for relatively long periods of time, such as for greater than 2 minutes to 24 hours or 48 hours, or 72 hours or longer. In yet other embodiments the SEI films are formed by precycling a battery cell. For example, graphite electrodes without the SEI film formed thereon (untreated graphite anodes) are placed in a battery cell containing one of the above-listed SEI pretreatment solutions and the cell is cycled until the SEI film is formed on the graphite anode and then the anode is removed for use in an embodiment of the disclosed battery systems. The graphite anode having an SEI film formed thereon is then removed from the SEI pretreatment solution (or the battery cell used for preforming the SEI film) and dried, such as by use of a cleaning, vacuum or drying cloth, for example, a KIMWIPE®.

### Examples

As shown in FIGS. 1 and 2, a graphite anode not having a SEI film (also referred to herein as an “untreated graphite anode”) was cycled in a non-EC (a non-alkyl carbonate based) electrolyte. FIG. 1 is a graph of the charge and discharge curves and cycling stability of the untreated graphite anode (i.e., no SEI film thereon) in a lithium-ion sulfur battery system, wherein the untreated graphite anode was cycled in an 1M LiTFSI (DOL/DME) electrolyte (E121) (an electrolyte that did not contain an alkyl carbonate such as EC). As can be seen in FIG. 1, the untreated graphite electrode can first be discharged (in an initial cycle) to about 600 mAh/g but in the immediately following cycles the specific capacity is near or at about 0 mAh/g. The inoperability of the graphite electrode in the absence of a preformed SEI film was further illustrated in the digital photograph of the anode in the “lithiated” state of FIG. 2 following the cycling. The untreated graphite electrode remains completely black, while an actually lithiated graphite anode would be golden in color. This data illustrates that the graphite electrode is not acting as active anode material in the absence of a SEI film (and no EC or other alkyl carbonate in the electrolyte to form SEI on the graphite during cycling to enable its reversible cycling).

FIG. 3 is a graph of charge and discharge curves and cycling stability of an embodiment of the preformed SEI film graphite electrode disclosed herein. In this example the graphite electrode with the preformed SEI film comprising an SEI film preformed from a 1M LiPF₆ in EC/DMC (1:2) (E102) pretreatment solution and the electrode was then cycled in 1M LiTFSI (DOL/DME) (E121) electrolyte (the concentration in alternative embodiments range from 0.1-10M or 1-5M). As can be seen, the graphite electrode having a preformed SEI film thereon is active, providing a relatively high specific capacity of over 300 mAh/g even after 12 cycles′.

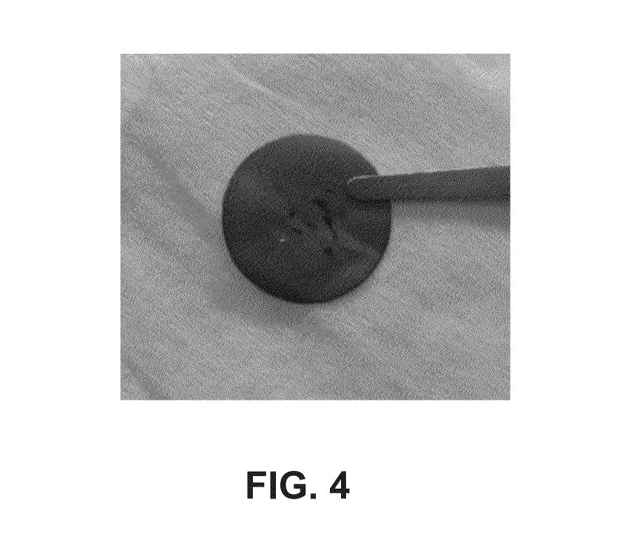

The graphite electrode having the preformed SEI film thereon is further shown as being active in FIG. 4, which is a digital photograph of the preformed SEI film graphite electrode of FIG. 3 at the discharged (lithiated) state after 10 cycles. The golden color of the graphite indicates the graphite is lithiated, which means it is an active anode material (it is a functioning electrode) in the battery system.

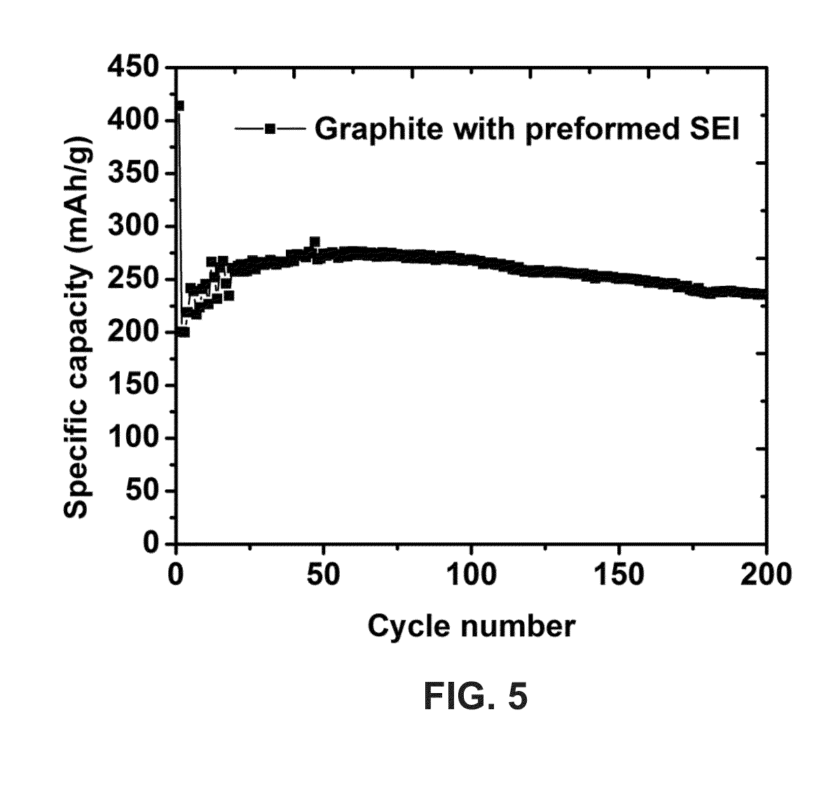

FIG. 5 is a graph of extended cycling data obtained from the cycling of a preformed SEI (EC-based) film graphite anode, cycled in 1M LiTFSI (DOL/DME) (E121) electrolyte (other concentrations, such as 0.1-10M or 1-5M are used in other embodiments). This data illustrates that the preforming of the EC-based SEI film on the graphite is very effective and provides a graphite electrode operable in non-alkyl carbonate electrolytes, which is stable for at least 100, or at least 200 cycles. By stable as used herein means the specific capacity does not decline more than 20% after 50 cycles of charge/discharge, or 100 cycles of charge/discharge or 200 cycles of charge/discharge.

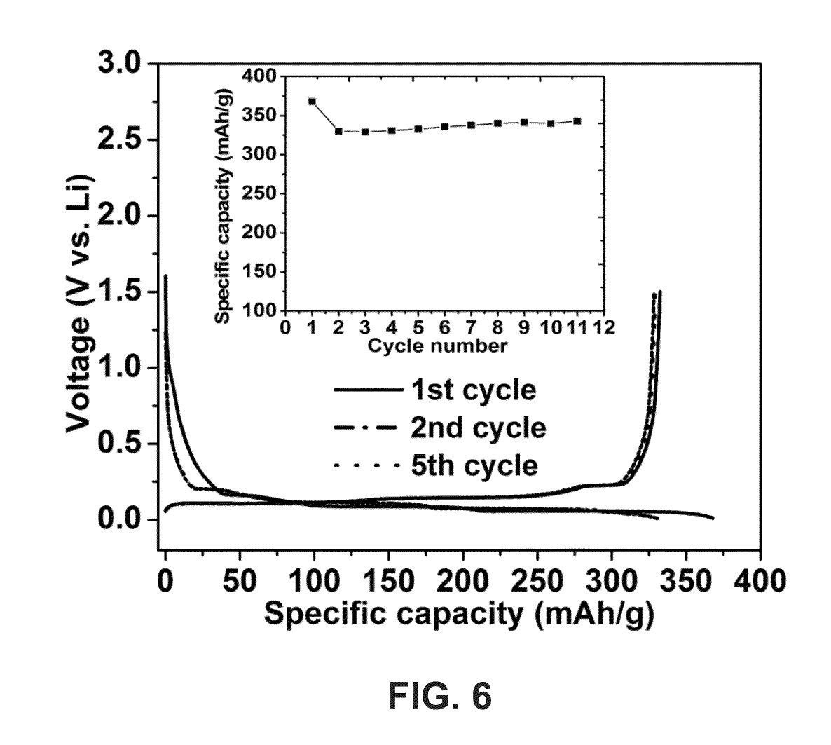

FIG. 6 is a graph of the cycling data obtained when first cycling an untreated graphite anode in 1M LiPF₆ in EC/DMC (1:2) (E102) pretreatment solution (electrolyte) to preform the SEI film thereon. The graphite anode having the preformed SEI film was then cycled in 1M LiTFSI (DOL/DME) electrolyte (E121). FIG. 6 data illustrates that following the preformation of SEI by precycling the graphite in a coin cell with E102: 1M LiPF6 in EC/DMC (1:2, V/V), the graphite electrode shows stable cycling in an E121 (i.e., 1M LiTFSI in DOL/DME (1:1, V/V) electrolyte, in the absence of EC).

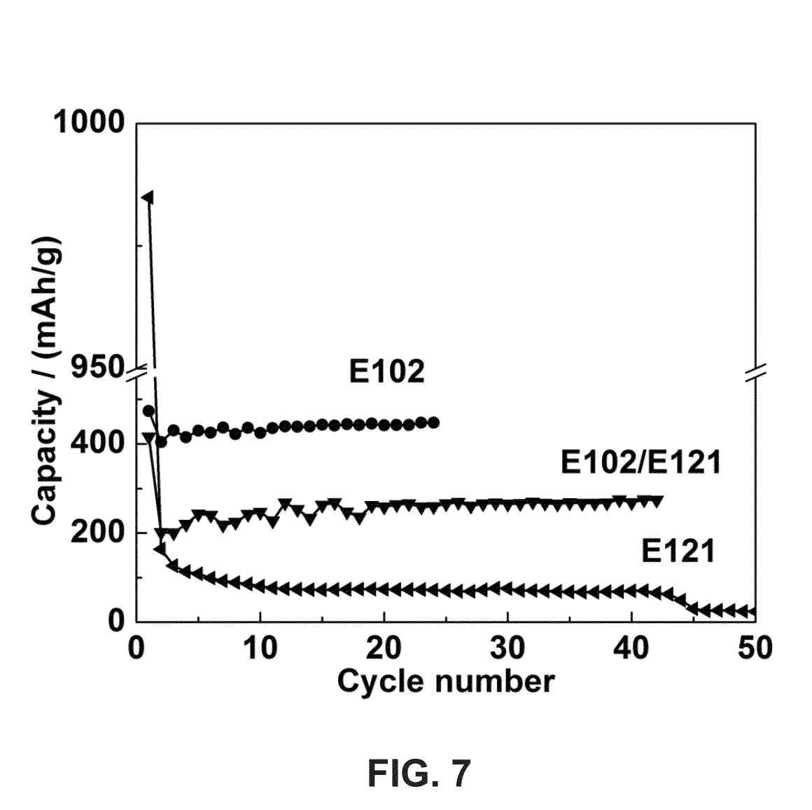

FIG. 7 is a graph of comparison data of the cycling stability of the preformed SEI film graphite electrode in different electrolytes. Graphite shows stable and high reversible capacities in EC containing, alkyl carbonate electrolyte (E102), while it decays very fast and loses activity as anode in the electrolyte that does not include an alkyl carbonate (E121). When the graphite was pretreated in E102 for the preformation of an SEI film and then cycled in E121 electrolyte, the reversibility of graphite electrode was significantly improved.

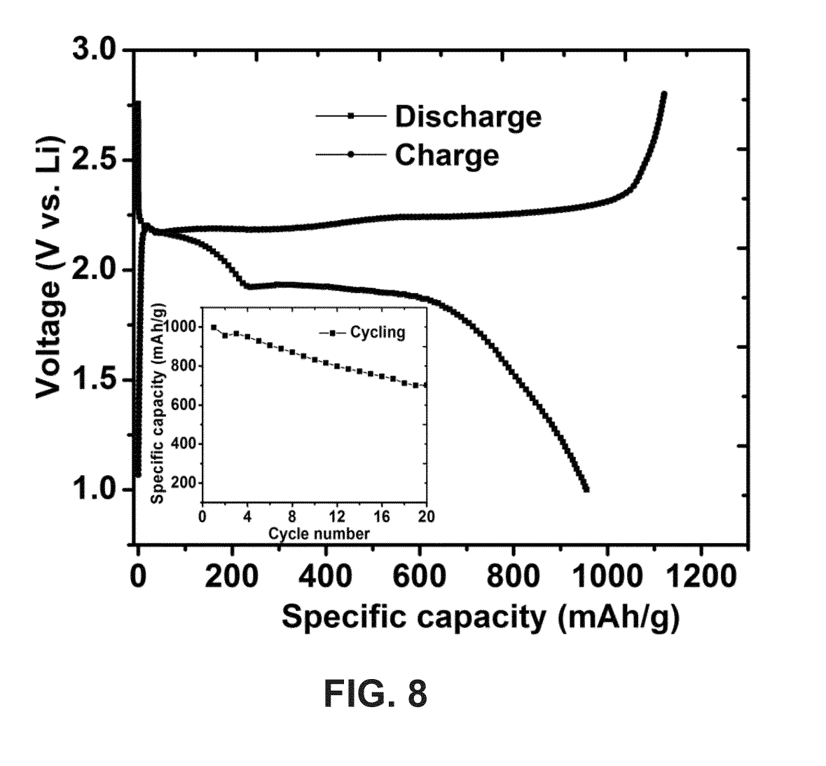

FIG. 8 is a graph of charge/discharge curves of an embodiment of the disclosed Li-ion sulfur full cell, with sulfur as cathode and a preformed SEI graphite anode. The cell exhibits a high reversible capacity of about 1000 mAh/g at a current density of 0.1 mA/cm² and can be cycled successfully. The preformed SEI film graphite anode was prepared by using a graphite electrode with mass loading of 5 mg/cm², dipping the electrode in E102 (1 M LiPF6 in EC/DMC) pretreatment solution for a minute and then wiping the treated electrode with a KIMWIPE. The preformed SEI film graphite electrode was then lithiated electrochemically in a coin cell with Li metal as the counter electrode. The pretreated graphite electrode (graphite electrode with a preformed SEI film) was then used as anode coupled with sulfur cathode to form a full cell.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A device comprising:
a lithium-ion sulfur battery system comprising
a graphite anode having a preformed SEI film, preformed in an alkyl carbonate pretreatment solution; and
an electrolyte not including an alkyl carbonate.

2. The lithium-ion sulfur battery system of claim 1 wherein the preformed SEI film alkyl carbonate pretreatment solution comprises EC.

3. The lithium-ion battery sulfur system of claim 1 wherein the preformed SEI film alkyl carbonate pretreatment solution comprises DMC.

4. The lithium-ion sulfur battery system of claim 1, wherein the preformed SEI film pretreatment solution further comprises SO₂, Li₂CO₃, K₂CO₃, LiBOB, ES, PS, VES, PES, VTC, FEC, VC, VEC, or mixtures thereof.

5. The lithium-ion sulfur battery system of claim 1 wherein the electrolyte comprises an ether-based electrolyte.

6. The lithium-ion sulfur battery system of claim 1 wherein the electrolyte comprises lithium bis-trifluoromethanesulfonamide (LiTFSI), lithium bis(fluorosulfonyl)amide (LiFSI), lithium 4,5-dicyano-2-(trifluoromethyl) imidazole (LiTDI) and/or lithium triflate and a solvent comprising dimethyl ether, 1,2-dimethoxyethane (DME), 1,3-dioxolane (DOL), dimethyl sulfoxide (DMSO), diethylene glycol dimethyl ether (diglyme), Triethylene glycol dimethyl ether (triglyme), tetra ethylene glycol dimethyl ether (tetraglyme), sulfone and their binary or ternary mixtures, and mixtures thereof.

7. The lithium-ion sulfur battery system of claim 1 wherein the graphite anode is a substantially pure graphite anode.

8. A device comprising:
a lithium-ion sulfur battery system further comprising
a graphite anode having a preformed SEI film; and
a non-alkyl carbonate electrolyte useful for charging and discharging the lithium-ion sulfur battery system without significant decline in specific capacity in over 10 cycles.

9. The lithium-ion sulfur battery system of claim 8 wherein the preformed SEI film comprises an EC-based SEI film.

10. The lithium-ion sulfur lithium-ion sulfur battery system of claim 8 wherein the preformed SEI film consists essentially of an EC-based SEI film.

11. A method comprising:
making a graphite electrode capable of use in a lithium-ion sulfur battery system by
providing an untreated graphite electrode, the graphite electrode having a surface;
providing an alkyl carbonate pretreatment solution;
prior to placing the graphite electrode in the lithium-ion sulfur battery system, immersing the untreated graphite electrode in the alkyl carbonate pretreatment solution thereby preforming a SEI film on the surface of the graphite electrode;
removing the graphite electrode having the preformed SEI film thereon from the pretreatment solution; and
placing the graphite electrode having the preformed SEI film thereon in an electrolyte, wherein the electrolyte does not comprise an alkyl carbonate.

12. The method of claim 11 further comprising charging and discharging the lithium-ion sulfur battery system with the preformed SEI film graphite electrode in the lithium-ion sulfur battery system.

13. The method of claim 11 further comprising placing the graphite electrode having the preformed SEI film thereon into a lithium-sulfur supercapacitor having an electrolyte that does not comprise alkyl carbonate.

14. The method of claim 11 wherein the SEI film pretreatment solution comprises EC, DMC, EMC, DEC, EC/DMC, EC/EMC, EC/DEC, EC/PC or mixtures thereof.

15. The method of claim 11 wherein the providing the alkyl carbonate pretreatment solution comprises providing a pretreatment solution comprising EC, EC and a co-solvent, EC and EMC, EC/DEC, EC and PC or EC and DMC.

16. The method of claim 15 wherein the providing the EC pretreatment solution comprises providing EC at a sufficient temperature that the EC is a liquid in the absence of a solvent.

17. A method comprising:
making a preformed SEI film graphite electrode by
providing an untreated graphite electrode;
providing an alkyl carbonate pretreatment solution;
precycling the untreated graphite electrode in the alkyl carbonate pretreatment solution thereby preforming an SEI film on the surface of the graphite electrode;
placing the preformed SEI film graphite electrode into a lithium-sulfur battery system; and
cycling the preformed SEI film graphite electrode in the lithium-sulfur battery system in an electrolyte, wherein the electrolyte does not comprise an alkyl carbonate.

18. The method of claim 17 wherein the preformed SEI film pretreatment solution comprises EC.

19. The method of claim 17 wherein the electrolyte comprises an ether compound.

20. The method of claim 17 wherein the electrolyte comprises lithium bis-trifluoromethanesulfonamide (LiTFSI), lithium bis(fluorosulfonyl)amide (LiFSI), lithium 4,5-dicyano-2-(trifluoromethyl) imidazole (LiTDI) and/or lithium triflate and a solvent comprising dimethyl ether, 1,2-dimethoxyethane (DME), 1,3-dioxolane (DOL), dimethyl sulfoxide (DMSO), diethylene glycol dimethyl ether (diglyme), triethylene glycol dimethyl ether (triglyme), tetra ethylene glycol dimethyl ether (tetraglyme), sulfone and their binary or ternary mixtures, and mixtures thereof.
